(19) United States
(12) Patent Application Publication
(10) Pub. No.: US 2006/0186172 A1
(43) Pub. Date: Aug. 24, 2006

(54) Lead free desoldering braid

(75) Inventors: Gary J. Klein, Los Angeles, CA (US); Susan D. Max, Kennesaw, GA (US)

Correspondence Address: Levenfeld Pearlstein, LLC (ILLINOIS TOOL WORKS), 2 North LaSalle Street, Suite 1300, CHICAGO, IL, 60602, US

(73) Assignee: Illinois Tool Works, Inc., Glenview, IL (US)

(21) Appl. No.: 11/062,187

(22) Filed: Feb. 18, 2005

(51) Int. Cl. B23K 1/00

(52) U.S. Cl. 228/19

(57) ABSTRACT

A braid for desoldering a printed circuit board or electrical component having a lead-free solder formed from a plurality of solid metal strands bundled together to form a bundle in which a plurality of bundles are braided with one another to form a braid. The braid is formed having a single ply and is configured for desoldering the printed circuit board or electrical component having a lead-free solder having a melting point temperature in excess of 183° C. (about 361° F.).

### BACKGROUND OF THE INVENTION

The present invention pertains to a desoldering member. More particularly, the present invention pertains to a braid that is configured for removing solder from, for example, printed circuit boards and electronic equipment, during the rework and repair of these electrical components.

Known desoldering braids have limited effectiveness on solders with melting points higher than 200° C. (392° F.). Currently U.S. electronics manufacturers use eutectic tin/lead solder which has a melting point of 183° C. (about 361° F.). Due to regulatory requirements in Europe, namely the Waste Electrical and Electronic Equipment (WEEE) Directive and Reduction of Hazardous Substances (RoHS) Regulation (European Union Directive 2002/95/EC) which bans the use of leaded solders in new electronics products sold in Europe as of Jul. 1, 2006, many manufacturers are now evaluating lead-free solders with melting points higher than 200° C. with plans to convert their production processes to lead-free solder prior to the deadline.

The known braids cannot effectively operate at these elevated solder (melting point) temperatures. These braids are fabricated from hollow tubes that are woven and subsequently flattened to form the braid. This results in a 2-ply construction with the opposing walls of the tube forming the plies. While these braids are effective for the lower temperature solders, the heat transfer rate is too low for effectively desoldering components having the higher melting point temperature.

Accordingly, there exists a need for a desoldering member that is effective with higher melting point temperature solders. Desirably, such a desoldering member is formed in a manner similar to known members, such as desoldering braids. More desirably, such a braid facilitates the desoldering operation by effectively increasing the heat transfer rate from the heat source to the solder that is to be removed.

### BRIEF SUMMARY OF THE INVENTION

A braid for desoldering a printed circuit board or electrical component is disclosed. The braid is configured for desoldering components (and boards) having a lead-free solder. The braid is formed from a plurality of solid metal strands bundled together to form a bundle. A plurality of bundles are braided with one another to form a braid.

The braid is formed having a single ply and is configured for desoldering the printed circuit board or electrical component having a lead-free solder having a melting point temperature in excess of 183° C. (about 361° F.).

A present braid is formed from solid copper wire strands. Optionally, the braid can include a flux coating on the braid. Fluxes include no clean flux, rosin flux and the like.

In a presently contemplated braid the bundle includes about 4 to about 12 strands of copper wire and preferably 7 strands and the strands have a gauge of about 40 to about 44 and preferably a gauge of 42. The braid includes about 9 to about 17 bundles of strands and preferably 13 bundles braided in a 2 over 2 configuration. Alternately, the braid can be formed in a 1 over 1 configuration.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a plan view of a lead free desoldering braid embodying the principles of the present invention;

FIG. 2 is an enlarged, close-up view of the braid shown in a 2 over 2 configuration;

FIG. 3 is an end view of the braid of FIG. 3; and

FIG. 4 illustrates and alternate braid formed in a 1 over 1 configuration.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

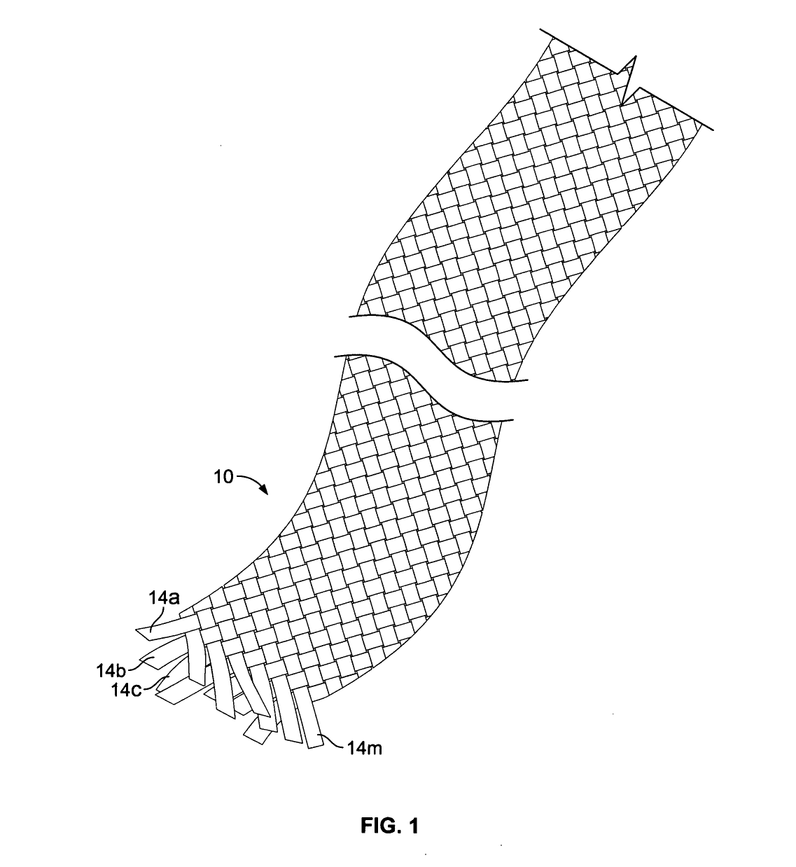

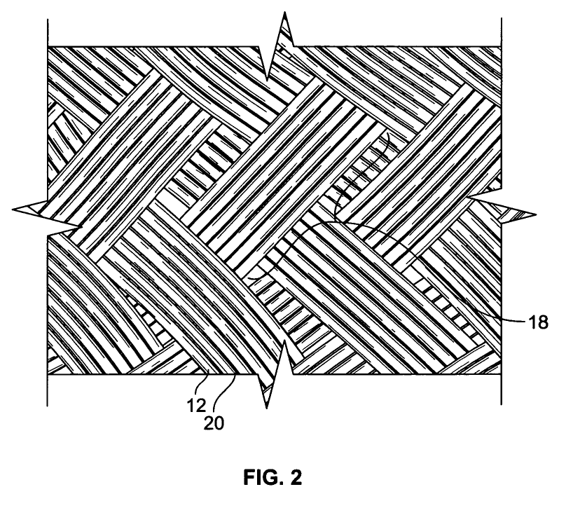

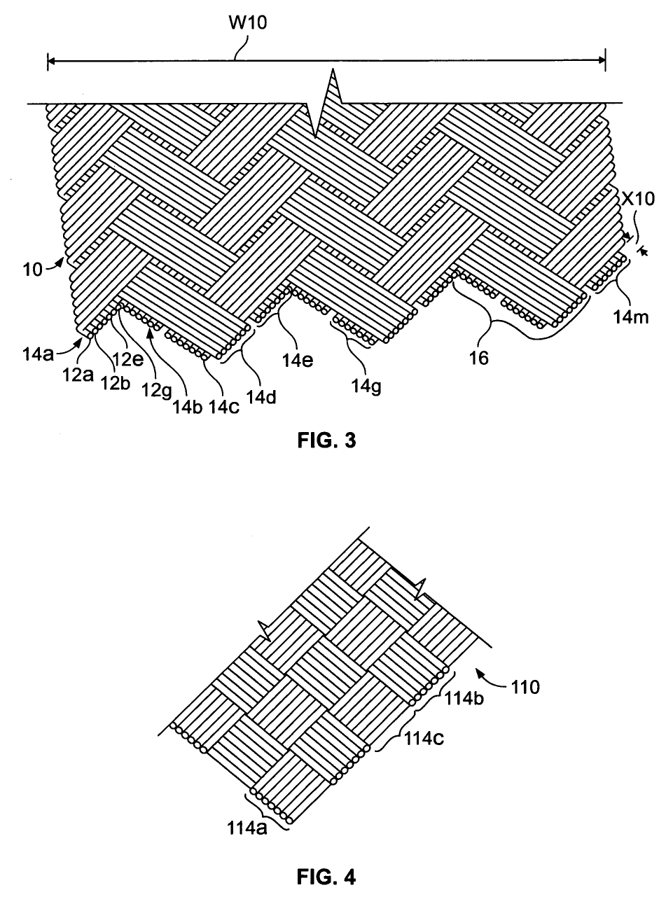

Referring now to FIG. 1, there is shown a desoldering braid 10 embodying the principles of the present invention. The braid 10 is formed as a single ply member or element. A plurality of solid strands 12 (e.g., 12a, 12b, 12c, . . . 12g) are grouped together to form a bundle 14 of strands 12. A plurality of bundles 14 (e.g., 14a, 14b, 14c, . . . 14m) are then braided together to form the braid 10. The braid 10 is formed as a single braided or interweaved layer (indicated generally at 16) in which each of the separate elements or, as in the present instance, strands 12 and bundles 14 are single ply. A present material for the desoldering braid 10 is copper. The configuration of the present braid 10 is in contrast to known braids in which the braided elements (i.e., tubes) are flattened which results in a two-ply configuration.

In a present braid 10, there are seven (7) strands 12 in each bundle 14, and thirteen (13) bundles 14 braided together to form the braid 10. In the braid 10, the strands 12 are 42 gauge wire. This produces a 13-7-42 braid. The braid 10 is formed (or woven) in a 2 over 2 configuration (indicated generally at 18) in which a bundle 14a is passed over (or passed under) the next two adjacent bundles 14b, 14c to form the woven braid 10. Such a braid 10 has a width w₁₀ of about 0.083 inches (±0.010 inches) and a thickness t₁₀ of about 0.014 inches (±0.003 inches). It is, however, contemplated that other wire gauges, number of strands 12 (in each bundle 14), numbers of bundles 14 (in the braid 10) and braiding configurations 18 can be used to form the braid 10 of the present invention to achieve additional sizes and dimensions. For example, it is contemplated that suitable braids can be formed as 13-7-42 braids (13 bundles of seven strands of 42 gauge wire), 13-5-42 braids (13 bundles of five strands of 42 gauge wire) and 13-7-40 braids (13 bundles of seven strands of 40 gauge wire), as well as other sizes, numbers and configurations. The number of strands 12 can vary from about 4 to 12 strands per bundle 14, the wire (strand 12) gauge from about 40 to about 44 and the number of bundles 14 per braid 10 from about 9 to about 17.

This present braided configuration contains about 20 to 24 picks per inch and measures about 0.083″ wide by 0.014″ thick. A pick is the distance between intersecting bundles (of wire). As set forth above, the present single thickness or single ply braid 10 (which resembles a ribbon), is unlike known desoldering braids having a 2-ply construction, in that the known braids are fabrication from a flattened tubular construction. It has been observed that considerably faster heat transfer (a greater heat transfer rate) occurs for melting lead-free solder when the single-ply braid is used for desoldering. This increases the speed and efficiency of the rework process and minimizes heat damage to the printed circuit board (PCB) and components. It has been found that the present braid functions to effectively remove solders having a melting point greater than about 183° C. (about 361° F.).

An alternate braid 10 is illustrated in FIG. 4. This braid is formed in a 1 over 1 configuration in which a bundle 114a alternates over and under each adjacent bundle 114b, 114c.

The braid 10, 10 can include a flux (indicated generally at 20), such as a high-temperature no clean flux. One suitable flux 20 is a no clean flux, varieties of which are commercially available, and can be suitably selected from Alpha Metals of Jersey City, N.J. This permits desoldering applications using higher temperatures, up to 400° C. (752° F.). Desoldering with a flux such as this is optimized without premature loss of flux to volatilization or degradation of the flux at higher temperatures. The residues remaining on the surface of the PCB when desoldering is complete are non-corrosive if left on the PCB. The residues from desoldering can be easily removed using solvent cleaners, if required. Another contemplated flux is a rosin flux.

It has been found that use of the present braid 10, 110 reduces the time needed to melt lead-free solder when a soldering iron (not shown) is used as a heat source. By applying the desoldering braid 10, 110 to the surface of the solder and touching the soldering iron to the desoldering braid 10, 110, heat is efficiently transferred through the desoldering braid 10, 110 to the solder to achieve the melting point of the solder. Solder may be removed in this manner from various locations on the PCB during rework and repair for the replacement of soldered components on the PCB. This technique can also be used to clean excess solder from the pads of the PCB after hot air removal of surface mount components to prepare the surface for the application of solder paste prior to hot air reflow of replacement components.

The manner in which the braid 10, 110 is formed will be recognized by those skilled in the art. For example, the braid 10, 110 may be formed using a flat braiding technique or, alternately, using a maypole braiding technique. All such braiding techniques are within the scope of the present invention.

All patents referred to herein, are hereby incorporated herein by reference, whether or not specifically do so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A braid for desoldering a printed circuit board or electrical component having a lead-free solder, comprising:
a plurality of solid copper metal strands bundled together to form a bundle;
a plurality of bundles braided with one another to form a braid; and
a flux coating on the braid,
wherein the braid is formed having a single ply and is configured for desoldering the printed circuit board or electrical component having a lead-free solder having a melting point temperature in excess of 183° C. (about 361° F.).

2-3. (canceled)

4. The braid in accordance with claim 1 wherein the flux is a no clean flux.

5. The braid in accordance with claim 1 wherein the flux is a rosin flux.

6. The braid in accordance with claim 1 wherein the bundle includes about 4 to about 12 strands of copper wire.

7. The braid in accordance with claim 6 wherein the copper wire has a gauge of about 40 to about 44.

8. The braid in accordance with claim 1 wherein the braid includes about 9 to about 17 bundles of strands.

9. The braid in accordance with claim 1 wherein the braid is braided in a 2 over 2 configuration.

10. The braid in accordance with claim 1 wherein the braid is braided in a 1 over 1 configuration.
